(19) United States
(12) Patent Application Publication
(10) Pub. No.: US 2008/0230347 A1
(43) Pub. Date: Sep. 25, 2008

(54) Interactive Vending Machines and a Method of Operating Same

(76) Inventors: Don Hart, Woodland Hills, CA (US); Guy Hart, Woodland Hills, CA (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(21) Appl. No.: 10/593,797

(22) PCT Filed: Mar. 21, 2005
(86) PCT No.: PCT/IL05/00322

§ 371 Date: May 16, 2008

(30) Foreign Application Priority Data
Mar. 21, 2004 (IL) 160979

(51) Int. Cl. G07F 9/02

(52) U.S. Cl. 194/219

(57) ABSTRACT

There is provided a vending machine for multiple product sales, including means for displaying multiple products; means for operating the machine and effecting the dispensing of any selected product; at least one display screen disposed adjacent to the means for displaying multiple products, and an electronic control unit for selectively controlling the display on the screen prior to, and/or during, and/or after a vending operation. A method for operating a vending machine is also provided.

### FIELD OF THE INVENTION

The present invention relates vending machines and more particularly to interactive vending machines and a method of operating same.

### BACKGROUND OF THE INVENTION

Vending machines are currently used for the sale of products such as snacks, coffee, soda, other cooled drinks, bulk candies, capsules, stickers, CD's, prepaid calling cards, gumballs, puzzle balls, bracelets, tickets and other products. Due to the competitive nature of the business, much effort has been expended on increasing the attraction of vending machines, in order to increase sales thereof and so to justify the investment made in buying, installing and maintaining these machines. Beyond improving the outer appearance of the machines, improvements included offering the customer a wider choice of products. For example, coffee machines offer over a dozen different options—type of coffee, quantity of milk and sugar and the like. Other improvements and modifications are focused on easing the task of the machine operator, for example, systems that provide information to a remote location of stock level in the various containers, an example of such system being disclosed in U.S. Pat. No. 5,608,643. A similar system including a video display screen displaying information about user purchases is disclosed in U.S. Pat. No. 5,822,216. A vending system for sales inside guestrooms is proposed in U.S. Pat. No. 5,339,250. An interactive self-service vending system for insurance policies is described in U.S. Pat. No. 5,845,256. U.S. Pat. No. 6,505,095 describes a system for providing remote audit, cashless payment, and interactive transaction capabilities in a vending machine. Several further U.S. Patents, e.g., U.S. Pat. Nos. 6,351,688 and 6,457,688, describe systems for remote communication with vending machines to track sales. U.S. Pat. No. 6,397,193 discloses a pricing system for vended articles.

The use of display screens intended for viewing by consumers has rarely exceeded the level of providing status announcements such as “Press button 6 to obtain product” and “Coffee being prepared, ready in 30 seconds.” etc. The use of full-size bright display screens to attract consumers is believed to have been tried in practice, only, perhaps, with respect to movie tapes and disc vending machines, for obtaining a short preview. In particular, there has been no attempt to match the display content to information relating to a particular customer. It is clear that nothing is gained by showing children video clips extolling the advantages of hearing aids, luxury cars and insurance policies, while adults have only a limited interest in the adventures of Donald Duck, Superman and Harry Potter.

Furthermore, today advertising is so pervasive that many consumers automatically “turn off” when exposed to advertisements on TV, radio, newspapers, billboards and the Internet. This has occurred as people learn by experience that 95% of all adverts are irrelevant to their present needs or payment capabilities. In the present invention, the vending machine proprietor has a possibility of more closely tailoring the nature of the video clip to the customer.

### DISCLOSURE OF THE INVENTION

It is therefore a broad object of the present invention to obviate the disadvantages of prior art vending machines and to provide an interactive vending machine and a method of operating same.

It is a further object of the present invention to provide an interactive vending method and machine directed to a selected group of buyers, such as children, and associating products on sale with a particular group of buyers.

It is still a further objection of the present invention to display pictures, cartoons or sales promotion material to attract interest of children and adults and induce sales.

It is yet further object of the present invention to relate the displayed material to the consumer's choice of product, and to some extent the consumer him/herself.

The present invention achieves the above objects by providing a vending machine for multiple product sales, comprising means for displaying multiple products; means for operating said machine and effecting the dispensing of any selected product; at least one display screen disposed adjacent to said means for displaying multiple products, and an electronic control unit for selectively controlling the display on said screen prior to, and/or during, and/or, after a vending operation.

The invention further provides a method for operating a vending machine comprising providing a vending machine as claimed in claim 1; providing at least one sensor to detect the presence of a person adjacent to the vending machine and to generate a signal when a person is detected, and activating by said signal a display on said screen attention-attraction and/or sales-promotion video.

In an embodiment of the present invention there is provided a vending machine further including a multiplicity of general-nature sales-promotion video clips arranged for preprogrammed display on said screen(s) before the vending operation of said machine.

In another embodiment of the present invention there is provided a vending machine further including at least one video clip specifically related to a consumer-selected product arranged for display on said screen(s) during, and for a limited time after, the vending operation of said consumer-selected product.

It will thus be realized that the novel vending machine of the present invention serves to attract customers and to promote further sales. Such further sales can either be repeats of the present selected item or of other items about which the consumer is informed by the display.

In still another embodiment of the invention, the vending machine is adapted to diffrentiate between a child and an adult, allowing the machine controller to select appropriate display material.

The invention also may include an embodiment provided with an Internet link so that the various video clips can be exchanged, deleted, or added to by an authorized operator, as required by changing circumstances.

### BRIEF DESCRIPTION OF THE DRAWINGS

The invention will now be described in connection with certain preferred embodiments with reference to the following illustrative figures, so that it may be more fully understood.

With specific reference now to the figures in detail, it is stressed that the particulars shown are by way of example and for purposes of illustrative discussion of the preferred embodiments of the present invention only, and are presented in the cause of providing what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice.

In the drawings:

FIG. 1 is a perspective view of a preferred embodiment of the vending machine according to the invention;

FIG. 2 is an elevational view of a multiple-screen embodiment able to detect the presence of people in its vicinity;

FIG. 3 is a schematic representation, partly in an exploded view of the interior of the vending machine shown in FIG. 1., as viewed from the rear;

FIG. 4 is a side view of an embodiment illustrating sensors for distinguishing between children and adults passing by;

FIG. 5 is a schematic and block diagram of an embodiment illustrating control of product selection and the electronic interface for activating the display, and

FIG. 6 is a diagrammatic representation of an embodiment allowing a remote system operation to change the content of the display material.

### DETAILED DESCRIPTION OF PREFERRED EMBODIMENTS

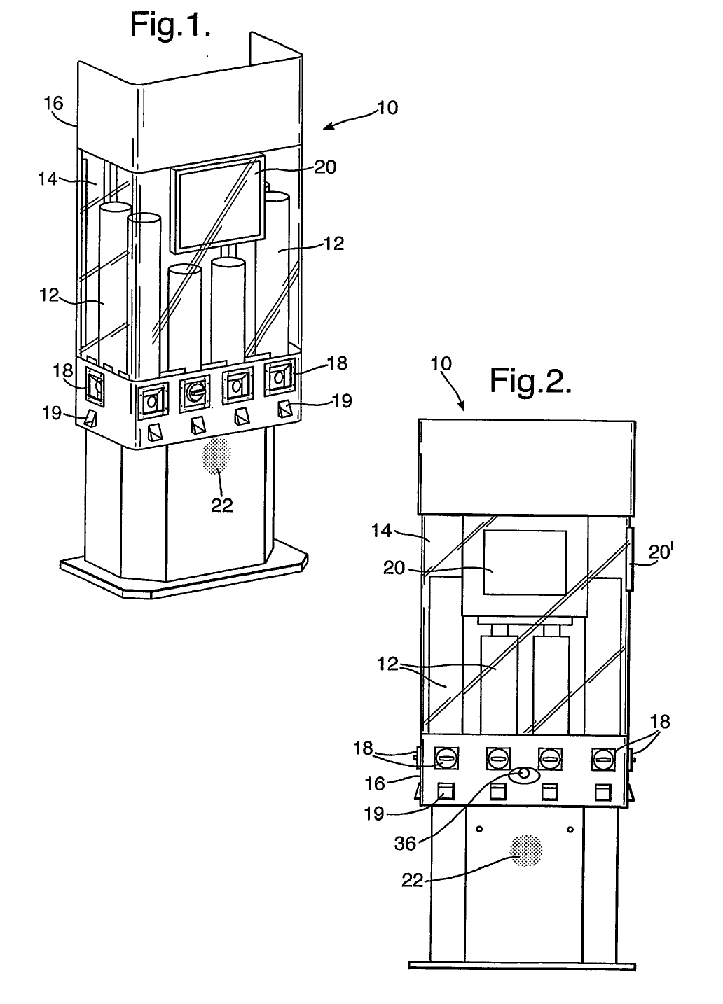

There is seen in FIG. 1 a vending machine 10 for the sale of e.g., six products. A display of all products offered is advantageously achieved by the use of transparent product storing and product displaying containers 12 and transparent windows 14 in the outer casing 16 of the machine. The vending machine 10 is equipped with per-se known or other mechanisms 18 for receiving coins and for effecting the dispensing of any selected product into the openable product apertures 19. As no novelty is claimed for these mechanisms, the details thereof will not be discussed herein.

A display screen 20 is disposed adjacent (above in the shown embodiment) to the windows 14 displaying multiple products. Preferably, the screen 20 is bright and about the same size of screens used to view a TV or as a computer monitor. Thus, in addition to being able to carry instructions, such as “Pull out drawer no. 3 to receive your lollipop”, the screen 20 is suitable for the showing of video clips or movie trailers. A loudspeaker 22 is provided to broadcast the sound track.

It should be noted that while in FIG. 1 the screen 20 is shown to be located above the elongated product displaying containers 12, the screen 20 could just the same be located at a lower level in between the containers 12 or even bellow them, so as to facilitate convenient viewing by children, as well as adults. The number, size and configuration of the containers 12, and their relative disposition with regard to the screen or screens, can be varied in consideration of many factors.

Referring now to FIG. 2, there is seen a vending machine 10 having multi-screens 20, 20′ further provided with one or more sensors 38, 40 located on different sides of the vending machine 10, including a screen. The sensors 38, 40 is suitably a motion detector or proximity switch, arranged to detect the presence of a person in the vicinity of the vending machine 10. In its normal state, the video display on the screen(s) 20 is “OFF”, however when the presence of a person is detected in the vicinity of the vending machine 10, a signal is generated. This signal activates the screen 20 by sending thereto one or more of the multiplicity of stored general-nature, attention attraction and sales-promotion video clips, preferably, but not necessarily, related to the products vendable by the machine. The displays on different screens need not be operated simultaneously, but only the screen on the side of the vending machine where the presence of a person was detected. Similarly, different displays may be effected on different screens.

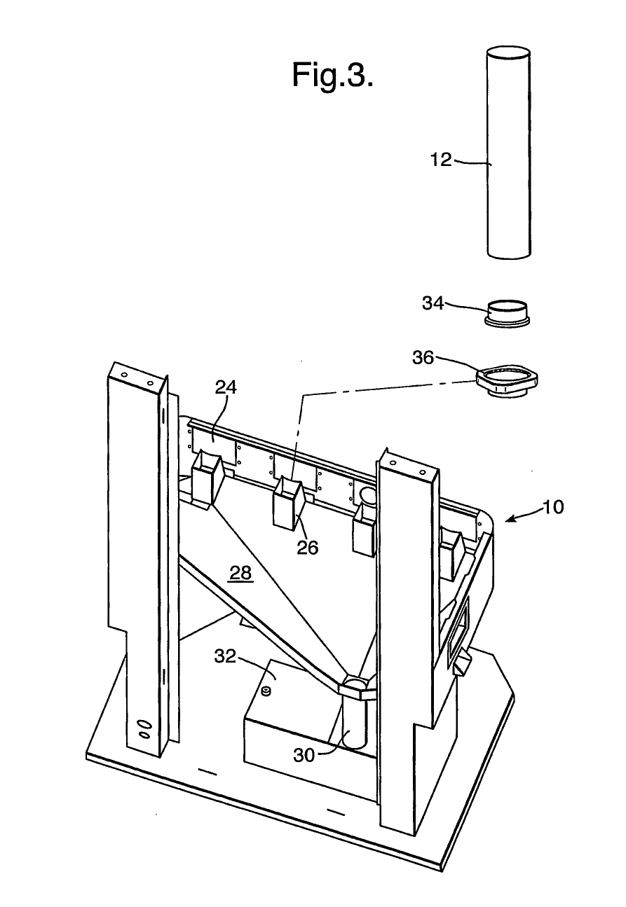

The interior of the subject vending machine is shown in FIG. 3. Seen are the back surfaces 24 of the plurality of the coin mechanisms 18 and the product chute 26. All the coins inserted by the customers in the mechanisms 18, after activating the gates (not shown) of the respective products, slide down the coin funnels 28 to a common coin chute 30, through which chute they slide or fold into a lockable coin collecting box 32. Also illustrated in an exploded view is a preferred embodiment of a removable product displaying container 12, configured as a transparent cylinder, having quick-connect fittings including a funnel cylinder adapter 34 and a connecting base 36, shaped and sized to fit the top of a product chute 26.

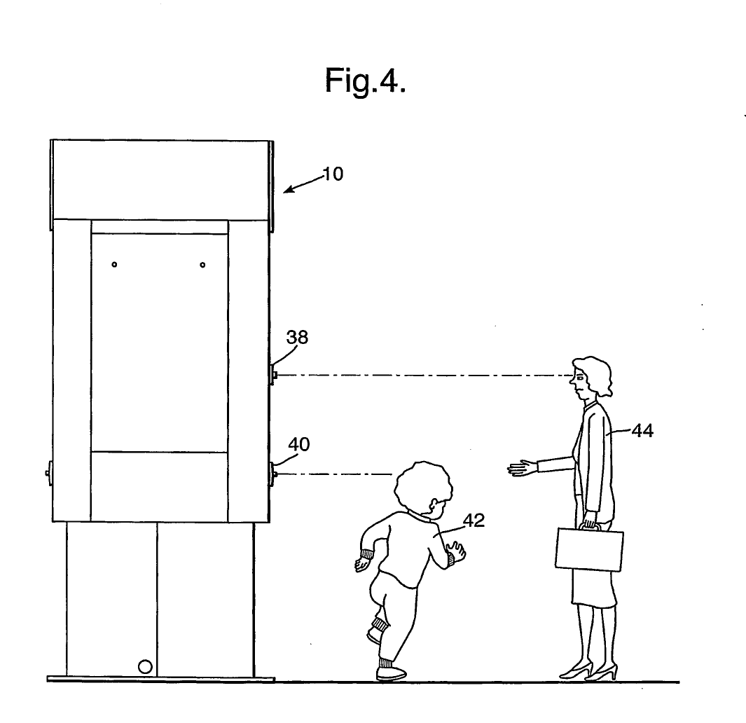

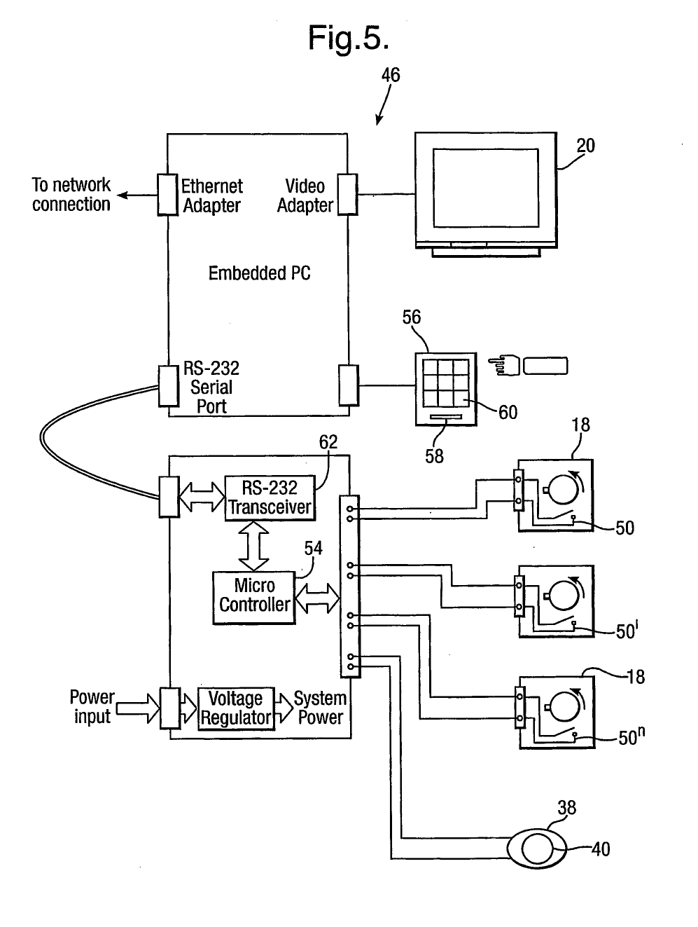

FIG. 4 illustrates a vending machine 10 wherein the display content is suited to either an adult or to a child's height. A plurality of sensors 38, 40, e.g., passive infrared sensors, are arranged to differentiate between the normal height of a child 42 who would use the machine 10, and between the height of an average adult person 44 to be detected in the vicinity thereof. The sensor outputs are electronically processed and generate a signal which is interpreted by the electronic control unit 46, seen in FIG. 5 as, e.g., a computer, for selecting a suitable display on the screen 20 seen in FIG. 1. Obviously, the two sensors could be housed in a single unit.

Thus an adult 44 approaching the machine might see promotional material relating to products (e.g., a candy bar, a snack, a hot cup of coffee, etc.) he/she may consider purchasing, while a child 42 will see clips relating to children's interests (e.g., bubble gum as advertised on TV). As mentioned hereinbefore, the machine 10 may have several screens 20, at least one of which may be located at a level from the ground, convenient for children's viewing.

An electronic interface control unit 46, seen in FIG. 5, controls the display on the screen or screens 20, 20′, and audio through speaker(s) 22. Prior to a consumer operating the vending machine, the control unit 46 sends to the screen(s) a single or a multiplicity of general-nature sales-promotion video clips. Actuation of a dispensing mechanism 18 is sensed by the control unit 46, which then sends to the screen(s) appropriate pre-selected messages or video clips.

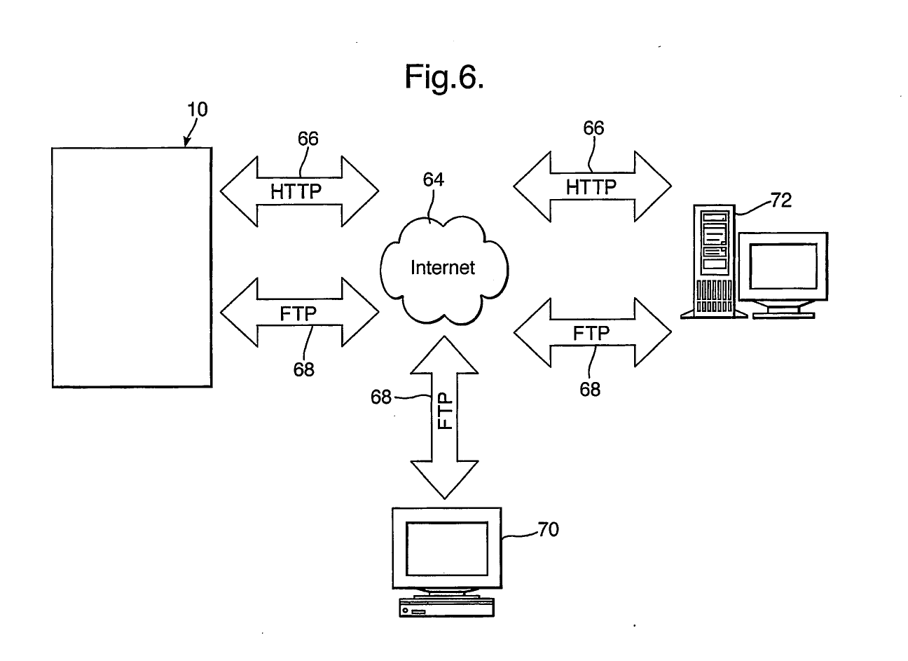

Further seen in FIG. 5 are the plurality of dispensing mechanisms 18 facilitating selection of display content in relation to the consumer's selected product(s). Video clips relating to all products vendable by the vending machine 10 are stored in a database inside the machine or outside thereof, as will be described hereinafter with reference to FIG. 6. Activation of any of the vending mechanisms 18, e.g., by rotating a knob or the like, is detected by any one of the switches 50, 50′ . . . 50ⁿ, relating to that particular product. The signal is recognized and processed by a microprocessor 52, including a microcontroller 54. The microcontroller 54 receives a signal from the proximity sensor(s) 38, (40) detecting the presence of a person near the machine, and upon the activation of a dispensing mechanism 18, selects a video clip specifically related to the selected product from the data-base. For example, if a consumer has selected product #5, a snack decorated with the “Blockbusters” logo, a film trailer could be shown relating to these characters. A person choosing product #3, a sugarless drink could be exposed to promotional material for further sugarless food products. After a pre-selected time period has elapsed following the vending operation, the electronic microcontroller 54 orders resumption of the display of general-nature, attention attraction and/or sales-promotional video clips.

Instead of, or in addition to, the coin-operated automatic activation of a selected product, there may be provided a dispensing mechanism 56, consisting of a card-operated key pad having a credit card insertion slot 58, a card reader, etc. (not shown), and product-selection keys or touch screens 60. The control unit 46, through its software, decides whether the signal is valid and then generates an encoded message, which is sent through the communication link 62 to a central computer.

Based on changing circumstances, it is desirable that means be provided for adding and deleting video clips stored in the vending machine. While it is possible to effect such changes at the same time as the machine is serviced (refilling product bins, removing accumulated coins), time can be saved by carrying out changes of display material from a central remote workstation, as seen in FIG. 6.

One of a plurality of vending machines 10 is seen connected to the Internet 64 by HTTP and FTP connection links 66, 68. The workstation 70 is used for adding and deleting display material. An enterprise server 72 stores all currently-needed video clips and other display material and supplies multiple vending machines therewith. Further HTTP and FTP connection links 66, 68 are provided as seen in the figure. The described arrangement thus allows the distribution of display material to be selected in accordance with the geographical location of each vending machine 10. In addition, the basic function of the arrangement may facilitate sending further video clips to be stored in the vending machine and to selectively delete therefrom selected previously-installed clips.

This arrangement also enables the vending machine to automatically control the available respective stocks of products and replenishing the stock, when necessary, by keeping track of the times each specific container is activated. Knowing the approximate amount of products contained in a container and the number of products released by a single activation, makes it easy to calculate the remaining stock in each container and to alert the operator when the stock reaches a certain predetermined level and to replenish the low level product.

It will be evident to those skilled in the art that the invention is not limited to the details of the foregoing illustrated embodiments and that the present invention may be embodied in other specific forms without departing from the spirit or essential attributes thereof. The present embodiments are therefore to be considered in all respects as illustrative and not restrictive, the scope of the invention being indicated by the appended claims rather than by the foregoing description, and all changes which come within the meaning and range of equivalency of the claims are therefore intended to be embraced therein.

What is claimed is:

1. A vending machine for multiple product sales, comprising:
means for displaying multiple products;
means for operating said machine and effecting the dispensing of any selected product;
at least one display screen disposed adjacent to said means for displaying multiple products, and
an electronic control unit for selectively controlling the display on said screen prior to, and/or during, and/or, after a vending operation.

2. The vending machine according to claim 1, further including a multiplicity of general-nature, attention-attraction and/or sales-promotion video arranged for preprogrammed display on said screen prior to the vending operation of said machine.

3. The vending machine according to claim 2, wherein an activation signal to display at least one of said multiplicity of general-nature, sales-attraction and/or sales-promotion video, is generated by a sensor detecting a person in the vicinity of said machine.

4. The vending machine according to claim 1, further comprising at least one sensor for detecting the presence of a person adjacent to the vending machine.

5. The vending machine according to claim 4, further comprising one or more of said sensors arranged to differentiate between a child and an adult detected to be present in the vicinity of said machine, and to generate a signal processed by said electronic control unit, for selecting a suitable display on said screen.

6. The vending machine according to claim 1, further comprising a loudspeaker for broadcasting the sound track of said display.

7. The vending machine as claimed in claim 1, further including at least one video specifically related to a consumer-selected product arranged for display on said screen during, and for a limited time after, the vending operation of said consumer-selected product.

8. The vending machine according to claim 1, further including a communication link between said machine and a remote central computer arranged to send additional video to be stored in said vending machine and to delete therefrom selected previously installed video.

9. The vending machine according to claim 1, comprising a multitude of display screens each facing a different side of the machine.

10. The vending machine according to claim 1, wherein the screen is located at a first level from the ground for convenient viewing by a child, an adult or both.

11. The vending machine according to claim 1, wherein said means for operating the machine are coins and said coins are propelled by coin funnels to a common coin collecting lockable box.

12. A method for operating a vending machine, comprising:
providing a vending machine as claimed in claim 1;
providing at least one sensor to detect the presence of a person adjacent to the vending machine and to generate a signal when a person is detected, and
activating by said signal a display on said screen attention-attraction and/or sales-promotion video.

13. The method as claimed in claim 12, further comprising providing one or more sensors on at least one side of the vending machine, enabling the differentiation between the presence of a child and an adult.

14. The method as claimed in claim 13, wherein the detection of a child or an adult by said sensor generates a signal activating an attention-attraction and/or sales-promotion video pre-selected to be appropriate for children or adults.

15. The method as claimed in claim 12, wherein upon actuation of said product-dispensing means, there is displayed on said screen a video relating to the product dispensed.

16. The method as claimed in claim 12, wherein there are provided a multiplicity of screens, and the displays on different screens, are not identical.

17. The method as claimed in claim 12, further comprising locating at least one screen at a first level from the ground for convenient viewing by a child, a short adult, or both.

18. The method as claimed in claim 17, wherein videos appropriate for children are displayed on screens disposed at a lower height than screens appropriate for adult viewing.
